(19) United States
(12) Patent Application Publication
(10) Pub. No.: US 2017/0150458 A1
(43) Pub. Date: May 25, 2017

(54) METHOD AND APPARATUS FOR ENHANCING PHR IN DUAL CONNECTIVITY

(71) Applicant: ALCATEL LUCENT, Boulogne-Billancourt (FR)

(72) Inventors: Tao Yang, Shanghai (CN); Chandrika Worrall, Newbury (GB)

(73) Assignee: Alcatel Lucent, Boulogne Billancourt (FR)

(21) Appl. No.: 15/127,696

(22) PCT Filed: Mar. 20, 2015
(86) PCT No.: PCT/IB2015/000541

§ 371 Date: Sep. 20, 2016

(30) Foreign Application Priority Data
Mar. 21, 2014 (CN) 201410108877.2

(51) Int. Cl. H04W 52/36; H04W 72/04; H04W 52/34

(52) U.S. Cl. CPC H04W 52/365; H04W 52/34; H04W 72/0413; H04W 92/20

(57) ABSTRACT

The invention provides solutions for enhancing PHR in a communication system of a dual connectivity. The solutions comprise the design of PHR MAC CE format for Se NB, the calculation of PHR_NT, and the design of including PHR_T and PHR_NT in the MAC PDU transmitted in the e_NBJ.

### FIELD OF THE INVENTION

The present invention relates to communication systems, and particularly to methods and apparatuses for enhancing PHR in dual connectivity.

### BACKGROUND OF THE INVENTION

According to current progress of DC (Dual Connectivity), following two agreements are achieved in RAN2 85 which are related to PHR (Power Headroom Report) reporting:
The PHR related timers and parameters are independently configured for each MAC entity;
PHR includes PH information of all activated cells in a UE (user equipment).

The first agreement means MeNB and SeNB will independently configure the parameters to trigger PHR transmission on MeNB and SeNB respectively. By default, when UE reports PHR on one base station, this PHR should include PH information of all active cells of this base station.

The second agreement means the PHR transmitted in one base station should also cover PH information of all active cells of another base station. That is, regardless the PHR is sent on which base station, UE should include in the PHR MAC CE the PH information of all active cells of both base stations.

### SUMMARY OF THE INVENTION

To simplify the discussion, definitions are given below:
The base station triggering the PHR reporting is called as eNB_T;
The base station which does not trigger the PHR reporting is called as eNB_NT;
The PHR carrying the PH information of eNB_T's active cells is called as PHR_T;
The PHR carrying the PH information of eNB_NT's active cells is called as PHR_NT.

According to above definitions, PHR transmission scheme in DC scenario are given as follows: eNB_T triggers the PHR transmission and the related PHR MAC CE is sent on eNB_T. And this PHR MAC CE should carry both of PHR_T and PHR_NT.

To realize this new PHR transmission scheme, following issues should be solved:
How to calculate PHR_NT when reporting PHR_T;
How to include PHR_T and PHR_NT in the PHR MAC CE transmitted in the eNB_T;
How to let eNB_T clearly differentiate PHR_T and PHR_NT.

According to R11 defined extended PHR MAC CE, there are two types of PH for Pcell, which refers to as type 1 and type 2. Where type 1 considers the PUSCH PH information while type 2 covers PUCCH PH information. While for Scell, PH only considers PUSCH information. And in the PHR MAC CE payload part, one bit-map based byte is used to indicate which active Scells has PH information presented in the MAC CE. This is show in FIG. 1.

As defined in R11, there are two types of active cells: Pcell and Scell(s). For Pcell, there are two types of PH information, with type 1 PH referring to PUSCH transmission and type 2 PH referring to PUCCH transmission. For Scell, only type 1 PH is presented, which refers to PUSCH transmission. For this extend PHR MAC CE, as shown in FIG. 1, the type 2 and type 1 PH value maybe calculated based on current transmission format or reference format which is indicated by “V” bit in FIG. 1.

Also, as indicated in FIG. 1, the PH information for Pcell and Scell(s) are placed in PHR MAC CE as fix order: Pcell PHR, type 1 and type 2 are placed at the first part, then following the PHR of Scell according to Scell index ascending order.

For SeNB in R12 DC scenario, there are also two kinds of transmission channels: PUSCH and PUCCH located at SPcell, and for other Scell of SeNB, only PUSCH is considered. Hence the issue to be solved by the present inventions is whether the PHR format shown in FIG. 1 is also valid to carry PH of SeNB active cells? Or any enhancement is needed? That is, if PHR is triggered by SeNB, what the corresponding PHR MAC CE looks like?

Therefore, one embodiment of the present invention proposes a method of providing a PHR MAC CE of a SeNB to the SeNB in a user equipment of a dual connectivity scenario, the method comprising:
sending the PHR MAC CE of the SeNB to the SeNB, the PHR MAC CE including PH information of SPcell of the SeNB and PH information of one or more active Scells of the SeNB, wherein the PH information of the SPcell is placed at a beginning position of a payload of the PHR MAC CE and the PH information of the Scells is placed at a subsequent position closely after the beginning position based on index sequences of the Scells, or the PH information of the SPcell is placed at an end position of a payload of the PHR MAC CE and the PH information of the Scells is placed at a preceding position closely before the end position based on index sequences of the Scells.

Advantageously, a bit referring to the index of the Scell is always set to be 0.

Advantageously, when the payload of the PHR MAC CE includes both PUSCH PH information and PUCCH PH information of the SPcell, the PUCCH PH information of the SPcell is placed at any one of the following positions in the payload of the PHR MAC CE:
directly placed at a position closely before the PUSCH PH information of the SPcell;
directly placed at a position closely after the PUSCH PH information of the SPcell.

Another embodiment of the present invention proposes a method of providing a PHR MAC CE of a SeNB to the SeNB in a user equipment of a dual connectivity scenario, the method comprising:
sending the PHR MAC CE of the SeNB to the SeNB, a payload of the PHR MAC CE including PH information of SPcell and PH information of one or more active Scells arranged based on index sequences of the SPcell and the Scells of the SeNB.

Advantageously, when the payload of the PHR MAC CE includes both PUSCH PH information and PUCCH PH information of the SPcell, the PUCCH PH information of the SPcell is placed at any one of the following positions in the payload of the PHR MAC CE:
directly placed at a position closely before the PUSCH PH information of the SPcell;
directly placed at a position closely after the PUSCH PH information of the SPcell;
placed at an end position of the payload of the PHR MAC CE;
directly placed at a position closely after a bit-map byte of the payload of the PHR MAC CE.

Another embodiment of the present invention proposes a method of calculating a PUCCH PH value of a Pcell/SPcell of an eNB_NT in a user equipment of a dual connectivity scenario, the method comprising:
calculating the PUCCH PH value of the Pcell/SPcell based on a reference format of a PUCCH transmission of the Pcell/SPcell.

Another embodiment of the present invention proposes a method of calculating a PUCCH PH value of a Pcell/SPcell of an eNB_NT in a user equipment of a dual connectivity scenario, the method comprising:
calculating the PUCCH PH value of the Pcell/SPcell based on a real PUCCH transmission format of the Pcell/SPcell in a current TTI.

Another embodiment of the present invention proposes a method of calculating a PUCCH PH value of a Pcell/SPcell of an eNB_NT in a user equipment of a dual connectivity scenario, the method comprising:
determining whether there is a PUCCH transmission of the Pcell/SPcell or not when the PUCCH PH value of the Pcell/SPcell is reported;
if there is no PUCCH transmission, then calculating the PUCCH PH value of the Pcell/SPcell based on a reference format of a PUCCH transmission of the Pcell/SPcell;
if there is a PUCCH transmission, then calculating the PUCCH PH value of the Pcell/SPcell based on a real PUCCH transmission format of the Pcell/SPcell when the PUCCH PH value of the Pcell/SPcell is reported.

Advantageously, the method further comprises:
sending the calculated PUCCH PH value of the Pcell/SPcell to an eNB_T via a PHR MAC CE, the PHR MAC CE further including indication information for indicating a calculating way of the PUCCH PH value of the Pcell/SPcell at the user equipment side.

Another embodiment of the present invention proposes a method of calculating PUSCH PH values of a Pcell/SPcell and one or more active Scells of an eNB_NT in a user equipment of a dual connectivity scenario, the method comprising:
calculating the PUSCH PH values of the Pcell/SPcell and the Scells respectively based on a reference format of a PUSCH transmission of the Pcell/SPcell and the Scells.

Another embodiment of the present invention proposes a method of calculating PUSCH PH values of a Pcell/SPcell and one or more active Scells of an eNB_NT in a user equipment of a dual connectivity scenario, the method comprising:
calculating the PUSCH PH values of the Pcell/SPcell and the Scells based on a current real PUSCH transmission format of the Pcell/SPcell and the Scells when the PUSCH PH values of the Pcell/SPcell and the Scells are reported.

Advantageously, the method further comprises:
sending the calculated PUSCH PH values of the Pcell/SPcell and the Scells to an eNB_T via a PHR MAC CE, wherein a MAC PDU carrying the PHR MAC CE further including information for indicating the current real transmission format of the eNB_NT.

Another embodiment of the present invention proposes a method of providing a PHR MAC CE to an eNB_T in a user equipment of a dual connectivity scenario, the method comprising:
sending a MAC PDU to the eNB_T, the MAC PDU including a PHR MAC CE corresponding to the eNB_T and a PHR MAC CE corresponding to an eNB_NT, wherein respective sub-headers of the two PHR MAC CEs include indication information for indicating PH information carried in a payload of the PHR MAC CE is whether PH information of active cells of the eNB_T or PH information of active cells of the eNB_NT.

Advantageously, the indication information is realized by any one of:
a “LCID” field in the sub-header of the PHR MAC CE;
a “F” filed in the sub-header of the PHR MAC CE.

Another embodiment of the present invention proposes a method of providing a PHR MAC CE to an eNB_T in a user equipment of a dual connectivity scenario, the method comprising:
sending a MAC PDU to the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a first bit-map byte, a second bit-map byte closely following the first bit-map byte, the PH information of the active cells of the eNB_T closely following the second bit-map byte, and the PH information of the active cells of the eNB_NT closely following the PH information of the active cells of the eNB_T, and wherein the first bit-map byte is used for indicating which active cell(s) of the eNB_T has PH information included in the payload of the PHR MAC CE and the second bit-map byte is used for indicating which active cell(s) of the eNB_NT has PH information included in the payload of the PHR MAC CE; and

a “R” bit in the first bit-map byte is used for indicating whether a PUCCH PH value of a Pcell/SPcell of the eNB_T is included in the PH information of the active cells of the eNB_T, and a “R” bit in the second bit-map byte is used for indicating whether a PUCCH PH value of a Pcell/SPcell of the eNB_NT is included in the PH information of the active cells of the eNB_NT; or

a “R” bit of a bit-map byte corresponding to a MeNB is used for indicating whether a PUCCH PH value of a Pcell of the MeNB is included in PH information of active cells of the MeNB.

Another embodiment of the present invention proposes a method of providing a PHR MAC CE to an eNB_T in a user equipment of a dual connectivity scenario, the method comprising:
sending a MAC PDU to the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a bit-map byte for indicating which active cell(s) of the eNB_T has PH information included in the payload of the PHR MAC CE and which active cell(s) of the eNB_NT has PH information included in the payload of the PHR MAC CE, and the payload of the PHR MAC CE further includes PH information of a Pcell of a MeNB closely following the bit-map byte, and PH information of one or more active Scells of the MeNB and all active cells of the SeNB, closely following the PH information of the Pcell of the MeNB, arranged based on index sequences of the active Scells of the MeNB and the all active cells of the SeNB, and wherein a “R” bit in the bit-map byte is used for indicating whether a PUCCH PH value of the Pcell of the MeNB is included in the payload of the PHR MAC CE.

Another embodiment of the present invention proposes a method of receiving a PHR MAC CE in a SeNB of a dual connectivity scenario, the method comprising:
receiving the PHR MAC CE of the SeNB from a user equipment, the PHR MAC CE including PH information of SPcell of the SeNB and PH information of one or more active Scells of the SeNB, wherein the PH information of the SPcell is placed at a beginning position of a payload of the PHR MAC CE and the PH information of the Scells is placed at a subsequent position closely after the beginning position based on index sequences of the Scells, or the PH information of the SPcell is placed at an end position of a payload of the PHR MAC CE and the PH information of the Scells is placed at a preceding position closely before the end position based on index sequences of the Scells;
determining whether [N_{L}−1−n−the number of Pcmax bytes]=0 or 1;
if [N_{L}−1−n−the number of Pcmax bytes]=0, then it is determined the payload of the PHR MAC CE includes only PUSCH PH information of the SPcell;
if [N_{L}−1−n−the number of Pcmax bytes]=1, then it is determined the payload of the PHR MAC CE includes both PUSCH PH information and PUCCH PH information of the SPcell;
ignoring index of the SPcell and decoupling the PHR MAC CE;

wherein N_{L} represents the byte number indicated by a “L” field in a sub-header of the PHR MAC CE, “1” represents the number of bit-map bytes “n” represents the number of active cells of the SeNB with PH information included in the payload of the PHR MAC CE, and “the number of Pcmax bytes” represents the number of “P”=1 in each PH information byte.

Another embodiment of the present invention proposes a method of receiving a PHR MAC CE in a SeNB of a dual connectivity scenario, the method comprising:
receiving the PHR MAC CE of the SeNB from a user equipment, a payload of the PHR MAC CE including PH information of SPcell and PH information of one or more active Scells arranged based on index sequences of the SPcell and the Scells of the SeNB;
determining whether [N_{L}−1−n−the number of Pcmax bytes]=0 or 1;
if [N_{L}−1−n−the number of Pcmax bytes]=0, then it is determined the payload of the PHR MAC CE includes only PUSCH PH information of the SPcell;
if [N_{L}−1−n−the number of Pcmax bytes]=1, then it is determined the payload of the PHR MAC CE includes both PUSCH PH information and PUCCH PH information of the SPcell;
decoupling the PHR MAC CE;

wherein N_{L} represents the byte number indicated by a “L” field in a sub-header of the PHR MAC CE, “1” represents the number of bit-map bytes “n” represents the number of active cells of the SeNB with PH information included in the payload of the PHR MAC CE, and “the number of Pcmax bytes” represents the number of “P”=1 in each PH information byte.

Another embodiment of the present invention proposes a method of processing a PUCCH PH value of a Pcell/SPcell of an eNB_NT in an eNB_T of a dual connectivity scenario, the method comprising:
exchanging with the eNB_NT each other's configured reference format of PUCCH transmission via an X2 interface;
receiving from a user equipment a PHR MAC CE in which the PUCCH PH value of the Pcell/SPcell of the eNB_NT is included;
decoupling the PUCCH PH value of the Pcell/SPcell in the PHR MAC CE according to the configured reference format of PUCCH transmission of the eNB_NT.

Another embodiment of the present invention proposes a method of processing a PUCCH PH value of a Pcell/SPcell of an eNB_NT in an eNB_T of a dual connectivity scenario, the method comprising:
exchanging with the eNB_NT each other's current configured PUCCH transmission format via an X2 interface;
receiving from a user equipment a PHR MAC CE in which the PUCCH PH value of the Pcell/SPcell of the eNB_NT is included;
decoupling the PUCCH PH value of the Pcell/SPcell in the PHR MAC CE according to the current configured PUCCH transmission format of the eNB_NT.

Advantageously, the method further comprises:
if the eNB_T updates its configured PUCCH transmission format, then sending the updated PUCCH transmission format to the eNB_NT via the X2 interface; or
if the eNB_NT updates its configured PUCCH transmission format, then receiving the updated PUCCH transmission format of the eNB_NT from the eNB_NT via the X2 interface.

Another embodiment of the present invention proposes a method of processing a PUCCH PH value of a Pcell/SPcell of an eNB_NT in an eNB_T of a dual connectivity scenario, the method comprising:
exchanging with the eNB_NT each other's configured reference format of PUCCH transmission and each other's current configured PUCCH transmission format via an X2 interface;
receiving from a user equipment a PHR MAC CE in which the PUCCH PH value of the Pcell/SPcell of the eNB_NT is included and information about a calculating way by which the PUCCH PH value of the Pcell/SPcell is calculated at the user equipment side;
decoupling the PUCCH PH value of the Pcell/SPcell in the PHR MAC CE based on the calculating way by which the PUCCH PH value of the Pcell/SPcell is calculated at the user equipment side and according to one of the configured reference format of PUCCH transmission of the eNB_NT and the current configured PUCCH transmission format of the eNB_NT corresponding to the calculating way.

Advantageously, the method further comprises:
if the eNB_T updates its configured PUCCH transmission format, then sending the updated PUCCH transmission format to the eNB_NT via the X2 interface; or
if the eNB_NT updates its configured PUCCH transmission format, then receiving the updated PUCCH transmission format of the eNB_NT from the eNB_NT via the X2 interface.

Another embodiment of the present invention proposes a method of processing PUSCH PH values of a Pcell/SPcell and one or more active Scells of an eNB_NT in an eNB_T of a dual connectivity scenario, the method comprising:
exchanging with the eNB_NT each other's configured reference format of PUSCH transmission via an X2 interface;
receiving from a user equipment a PHR MAC CE in which the PUSCH PH values of the Pcell/SPcell and the Scells of the eNB_NT are included;
decoupling the PUSCH PH values of the Pcell/SPcell and the Scells in the PHR MAC CE according to the configured reference format of PUSCH transmission of the eNB_NT.

Another embodiment of the present invention proposes a method of processing PUSCH PH values of a Pcell/SPcell and one or more active Scells of an eNB_NT in an eNB_T of a dual connectivity scenario, the method comprising:
receiving from a user equipment a PHR MAC CE in which the PUSCH PH values of the Pcell/SPcell and the Scells of the eNB_NT are included, a MAC PDU carrying the PHR MAC CE further including information for indicating a current real transmission format of the eNB_NT;
decoupling the PUSCH PH values of the Pcell/SPcell and the Scells in the PHR MAC CE according to the current real transmission format of the eNB_NT.

Another embodiment of the present invention proposes a method of distinguishing PHR MAC CEs in an eNB_T of a dual connectivity scenario, the method comprising:
receiving a MAC PDU from a user equipment, the MAC PDU including a PHR MAC CE corresponding to the eNB_T and a PHR MAC CE corresponding to an eNB_NT, wherein respective sub-headers of the two PHR MAC CEs include indication information for indicating PH information carried in a payload of the PHR MAC CE is whether PH information of active cells of the eNB_T or PH information of active cells of the eNB_NT;
distinguishing the PHR MAC CE corresponding to the eNB_T and the PHR MAC CE corresponding to the eNB_NT based on the indication information in the respective sub-headers of the two PHR MAC CEs.

Another embodiment of the present invention proposes a method of processing a PHR MAC CE in an eNB_T of a dual connectivity scenario, the method comprising:
receiving a MAC PDU from the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a first bit-map byte, a second bit-map byte closely following the first bit-map byte, the PH information of the active cells of the eNB_T closely following the second bit-map byte, and the PH information of the active cells of the eNB_NT closely following the PH information of the active cells of the eNB_T, and wherein the first bit-map byte is used for indicating which active cell(s) of the eNB_T has PH information included in the payload of the PHR MAC CE and the second bit-map byte is used for indicating which active cell(s) of the eNB_NT has PH information included in the payload of the PHR MAC CE; and a “R” bit in the first bit-map byte is used for indicating whether a PUCCH PH value of a Pcell/SPcell of the eNB_T is included in the PH information of the active cells of the eNB_T, and a “R” bit in the second bit-map byte is used for indicating whether a PUCCH PH value of Pcell/SPcell of the eNB_NT is included in the PH information of the active cells of the eNB_NT;
determining a terminating position of the PH information of the active cells of the eNB_T and decoupling the PH information corresponding to the active cells of the eNB_T in the payload of the PHR MAC CE and the PH information corresponding to the active cells of the eNB_NT in the payload of the PHR MAC CE based on the “R” bit in the first bit-map byte and the “R” bit in the second bit-map byte.

Another embodiment of the present invention proposes a method of processing a PHR MAC CE in an eNB_T of a dual connectivity scenario, the method comprising:
receiving a MAC PDU from the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a first bit-map byte, a second bit-map byte closely following the first bit-map byte, the PH information of the active cells of the eNB_T closely following the second bit-map byte, and the PH information of the active cells of the eNB_NT closely following the PH information of the active cells of the eNB_T, and wherein the first bit-map byte is used for indicating which active cell(s) of the eNB_T has PH information included in the payload of the PHR MAC CE and the second bit-map byte is used for indicating which active cell(s) of the eNB_NT has PH information included in the payload of the PHR MAC CE; and a “R” bit of a bit-map byte corresponding to a MeNB is used for indicating whether a PUCCH PH value of a Pcell of the MeNB is included in PH information of active cells of the MeNB;
determining whether a PUCCH PH value of a SPcell of a SeNB is included in PH information of active cells of the SeNB based on the “R” bit of the bit-map byte corresponding to the MeNB;
determining a terminating position of the PH information of the active cells of the eNB_T and decoupling the PH information corresponding to the active cells of the eNB_T in the payload of the PHR MAC CE and the PH information corresponding to the active cells of the eNB_NT in the payload of the PHR MAC CE based on whether the PUCCH PH value of the Pcell of the MeNB is included in PH information of the active cells of the MeNB and whether the PUCCH PH value of the SPcell of the SeNB is included in the PH information of the active cells of the SeNB.

Advantageously, “R”=1 of the bit-map byte corresponding to the MeNB is used for indicating the PUCCH PH value of the Pcell of the MeNB is included in the payload of the PHR MAC CE, and “R”=0 is used for indicating the PUCCH PH value of the Pcell of the MeNB is not included in the payload of the PHR MAC CE, wherein whether the PUCCH PH value of the SPcell of the SeNB is included in the PH information of the active cells of the SeNB or not is determined by the followings ways:

when “R”=1,
if [N_{L}−2−2−the number of active bits in the first bit-map type and the second bit-map type−the number of Pcmax bytes]=1, then the PUCCH PH value of the SPcell of the SeNB is included in the PH information of the active cells of the SeNB;
if [N_{L}−2−2−the number of active bits in the first bit-map type and the second bit-map type−the number of Pcmax bytes]=0, then the PUCCH PH value of the SPcell of the SeNB is not included in the PH information of the active cells of the SeNB;

wherein N_{L} represents the byte number indicated by a “L” field in a sub-header of the PHR MAC CE, the first “2” in the equation represents PUCCH PH byte and PUSCH PH byte of the Pcell of MeNB, the second “2” in the equation represents the number of bit-map bytes, and “the number of active bits” represents the number of all active Scells of the MeNB and the SeNB;

when “R”=0,
if [N_{L}−1−2−the number of active bits in the first bit-map type and the second bit-map type−the number of Pcmax bytes]=1, then the PUCCH PH value of the SPcell of the SeNB is included in the PH information of the active cells of the SeNB;
if [N_{L}−1−2−the number of active bits in the first bit-map type and the second bit-map type−the number of Pcmax bytes]=0, then the PUCCH PH value of the SPcell of the SeNB is not included in the PH information of the active cells of the SeNB;

wherein N_{L} represents the byte number indicated by a “L” field in a sub-header of the PHR MAC CE, the first “1” in the equation represents PUSCH PH byte of the Pcell of MeNB, the second “2” in the equation represents the number of bit-map bytes, and “the number of active bits” represents the number of all active Scells of the MeNB and the SeNB.

Another embodiment of the present invention proposes a method of processing a PHR MAC CE in an eNB_T of a dual connectivity scenario, the method comprising:
receiving a MAC PDU from the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a bit-map byte for indicating which active cell(s) of the eNB_T has PH information included in the payload of the PHR MAC CE and which active cell(s) of the eNB_NT has PH information included in the payload of the PHR MAC CE, and the payload of the PHR MAC CE further includes PH information of a Pcell of a MeNB closely following the bit-map byte, and PH information of one or more active Scells of the MeNB and all active cells of the SeNB, closely following the PH information of the Pcell of the MeNB, arranged based on index sequences of the active Scells of the MeNB and the all active cells of the SeNB, and wherein a “R” bit in the bit-map byte is used for indicating whether a PUCCH PH value of the Pcell of the MeNB is included in the payload of the PHR MAC CE;
determining whether a PUCCH PH value of a SPcell of the SeNB is included in the PH information of the active cells of the SeNB or not based on the “R” bit in the bit-map byte.

Advantageously, “R”=1 of the bit-map byte is used for indicating the PUCCH PH value of the Pcell of the MeNB is included in the payload of the PHR MAC CE, and “R”=0 is used for indicating the PUCCH PH value of the Pcell of the MeNB is not included in the payload of the PHR MAC CE, wherein whether the PUCCH PH value of the SPcell of the SeNB is included in the payload of the PHR MAC CE or not is determined by the followings ways:

when “R”=1,
if [N_{L}−2−1−the number of active bits−the number of Pcmax bytes]=1, then the PUCCH PH value of the SPcell of the SeNB is included in the payload of the PHR MAC CE;
if [N_{L}−2−1−the number of active bits−the number of Pcmax bytes]=0, then the PUCCH PH value of the SPcell of the SeNB is not included in the payload of the PHR MAC CE;

wherein N_{L} represents the byte number indicated by a “L” field in a sub-header of the PHR MAC CE, the first “2” in the equation represents PUCCH PH byte and PUSCH PH byte of the Pcell of MeNB, the second “1” in the equation represents the number of bit-map bytes, and “the number of active bits” represents the number of all active Scells of the MeNB and the SeNB;

when “R”=0,
if [N_{L}−1−1−the number of active bits−the number of Pcmax bytes]=1, then the PUCCH PH value of the SPcell of the SeNB is included in the payload of the PHR MAC CE;
if [N_{L}−1−1−the number of active bits−the number of Pcmax bytes]=0, then the PUCCH PH value of the SPcell of the SeNB is not included in the payload of the PHR MAC CE;

wherein N_{L} represents the byte number indicated by a “L” field in a sub-header of the PHR MAC CE, the first “1” in the equation represents PUSCH PH byte of the Pcell of MeNB, the second “1” in the equation represents the number of bit-map bytes, and “the number of active bits” represents the number of all active Scells of the MeNB and the SeNB.

Advantageously, the method further comprises:
exchanging with the eNB_NT each other's configured index information of active cells via an X2 interface.

The respective aspects of the invention will become more apparent from the following description of particular embodiments thereof.

### BRIEF DESCRIPTION OF DRAWINGS

Other features, objects and advantages of the invention will become more apparent upon review of the following detailed description of non-limiting embodiments taken with reference to the drawings in which:

FIG. 1 illustrates a schematic view of the existing R11 defined extended PHR MAC CE;

FIG. 2 illustrates a schematic view of the sub-header of PHR MAC CE according to one embodiment of the invention;

FIG. 3 illustrates a schematic view of PHR MAC CE according to one embodiment of the invention; and

FIG. 4 illustrates a schematic view of PHR MAC CE according to one embodiment of the invention.

Identical or similar reference numerals in the drawings denote identical or similar components.

### DETAILED DESCRIPTION OF EMBODIMENTS

The respective embodiments of the invention will be described in details in conjunction with drawings.

1. PHR MAC CE Format Design for SeNB

As analyzed above, for SeNB, two types of cells will be configured to UE: SPcell and normal one or more Scells. For SPcell, two types of transmission will happen: PUCCH and PUSCH. Hence still two types of PH information will be reported for SPcell: type 1 covers PUSCH PH information and type 2 covers PUCCH PH information. For other Scell, only PUSCH PH information is covered. Thus the problem to be solved by the invention is how to put SPcell PH information (type 1 and/or type 2) and Scell PH information (type 1) in SeNB MAC CE? What is UE operation when receiving SeNB PHR MAC CE?

Regarding the problem, two options are proposed as below:

Option 1: SPcell PH information (type 1 and/or type 2) is put in the fixed position as R11 defined extended MAC CE format;

Option 2: SPcell PHR information (type 1 and/or type 2) is put in the variable position according to SPcell and Scell index order, such as the ascending order or descending order.

For option 1, the type 1 and/or type 2 of SPcell and typ1 of Scell are placed as fixed order, as R11 defined: type 1 and/or type 2 of SPcell is placed at the beginning position, closely following the bit-map byte, of the payload of PHR MAC CE, then following type 1 and/or type 2 of SPcell is type 1 of Scell which is arranged according to Scell index ascending order or descending order. Certainly, type 1 and/or type 2 of SPcell can also be placed at the end position of the payload of PHR MAC CE. Correspondingly, type 1 of Scell is placed at a position closely prior to the end position according to Scell index order. But the issue is, for SeNB, the SPcell will have an index which may not be 000 and may be changed during SPcell changing procedure. Hence if the SPcell PH information is placed at the beginning position or end position, then in one example, one bit referring to the SPcell index should be ignored since the SPcell PH information is already placed at the beginning position or end position of the PHR MAC CE payload. That is, for option 1, SeNB should ignore the bit referring to SPcell index regardless what this bit is set so as to guarantee SeNB will correctly decouple the PHR MAC CE. Otherwise, if SeNB does not ignore this bit, SeNB may consider there is also one PH linked to this bit if it is set to be 1. That is to say, SeNB will make mistake because the PH referring to one Scell will be regarded as referring to SPcell. Certainly, in another example, this bit referring to SPcell index can be set to be “0” such that SeNB will consider there is no PH located at the position linked to this bit.

For option 1, if type 2 is presented in the payload of PHR MAC CE, then UE must be clear where the type 2 is placed. For example, the PH information of type 2 is placed just before the PH information of type 1, or the PH information of type 2 is placed just after the PH information of type 1. Correspondingly, if type 2 is presented in the payload of PHR MAC CE, then SeNB can locate PH value of type 2 according to the above position.

For option 2, all PH information (regardless for SPcell or Scell), is placed in the PHR MAC CE payload according to cell index sequence, such as by ascending order or descending order. For this option, the PH information of SPcell (type 1 and/or type 2) may be placed at any position of the payload of PHR MAC CE according to different SPcell index, for example, at the beginning position or the end position of PHR MAC CE payload or any position other than the beginning position and end position.

For option 2, if type 2 is presented in the payload of PHR MAC CE, then UE must be clear where the type 2 is placed. For example, type 2 PH information can be placed at a fixed position, such as just before type 1 PH information, or just after type 1 PH information, or at the end position of PHR MAC CE payload or closely following the bit-map byte of PHR MAC CE payload. If type 2 is presented in the payload of PHR MAC CE, then SeNB can locate PH value of type 2 according to the above position.

For option 1 and option 2, SeNB must be clear whether type 1 or type 1+type 2 are presented for SPcell. This can be done by following ways:

If [N_{L}−1(the number of bit-map bytes)−n(type 1 of all active cells, which is the number of bits set to be 1 in the bit-map byte)−the number of Pcmax bytes]=0, then only type 1 is presented for SPcell.

If [N_{L}−1−n−the number of Pcmax bytes]=1, then both type 1 and type 2 are presented for SPcell.

Where N_{L} refers to the byte number indicated by the “L” field in PHR MAC CE sub-header; “1” refers to the number of bit-map bytes which is the first byte of PHR MAC CE payload; “n” refers to the number of active cells with PH information included in the PHR MAC CE payload, which is the number of bit=1 in the bit-map byte; the number of Pcmax is the number of “P”=1 in each PH value byte. Here SeNB can detect the number of Pcmax byte by byte starting from the first PH information. If “P”=1, then SeNB knows Pcmax is following and SeNB will skip the Pcmax byte and go to next PH value part and check the “P” number, and go on. Based on the above two principles, UE will be clear on the SPcell PH content.

So, as can be seen, for PHR of SeNB, new PHR MAC CE format should be defined.

2. The Calculation of PHR_NT

As discussed above, when UE sends PHR_T on eNB_T, UE should also send PHR_NT of eNB_NT on eNB_T. It is clear that PHR_NT should cover PH information of all active cells of eNB_NT. PHR_NT contents may have following two situations:

Situation 1: If the eNB_NT is MeNB, then PHR_NT should include PH information for Pcell and PH information for all current active Scells. Pcell PH information will cover type 1 and/or type 2, while Scells' PH information will only include type 1.

Situation 2: If eNB_NT is SeNB, then PHR_NT should include PH information for SPcell and PH information for all other current active Scells. SPcell PHR may include type 1 and/or type 2, while the active Scells' PH information will only include type 1

So, as can be seen, regardless eNB_NT is MeNB or SeNB, the PHR_NT may include type 1 and/or type 2 and multiple type 1. For simplicity, they are referred to as type 1_NT and type 2_NT, where type 1_NT is for Pcell (SPcell) and Scells, type 2_NT is only for Pcell (SPcell). To correctly report PHR_NT, the first issue to be solved is how to calculate type 1_NT and type 2_NT. This issue is in fact on how to select the transmission format to calculate the type 1_NT or type 2_NT. The information should be known to eNB_T, and the purpose is to guarantee eNB_T can correctly decouple the received PHR_NT. Otherwise the received PHR_NT may be useless for eNB_T. The following options are proposed on how to calculate type 1_NT/type 2_{—} NT.

For type 2_NT calculation, following three options are proposed:

Option 1: Type 2_NT is always calculated based on PUCCH reference format;

Option 2: type 2_NT is always calculated based on PUCCH real transmission format in current TTI;

Option 3: type 2_NT is calculated based on current PUCCH transmission situation when type 2_NT is reported.

For option 1, the reference format for PUCCH transmission should be first exchanged between MeNB and SeNB, and the purpose is to guarantee these two base stations know each other's PUCCH reference format. Then when eNB_T receives the type 2_NT, eNB_T can use eNB_NT configured PUCCH reference format to decouple the received type 2_NT. If one base station changes its PUCCH reference format, it should also inform another base station over X2 interface. Thus it is required to define new X2 message/procedure to exchange each other's configured PUCCH reference format to support type 2_NT reporting to eNB_T.

For option 2, the type 2_NT is calculated based on real PUCCH transmission format when the type 2_NT is reported. The rationality of this option is the transmission format for PUCCH is not dynamically changed per TTI manner but only semi-statically changed. Hence it is possible that eNB_T and eNB_NT first exchange each other's current configured PUCCH transmission format so that type 2_NT can be correctly decoupled by eNB_T. If one base station changes its configured PUCCH transmission format, it should also notice another base station on this change to guarantee the type 2_NT can be correctly decoupled. Certainly, the real PUCCH transmission format can be notified to eNB_T by UE.

For option 3, it is based on the PUCCH transmission situation when type 2 is report. That is, if there is no PUCCH transmission, then the type 2 is calculated based on reference format. On the other hand, if PUCCH transmission happens when type 2_NT is triggered, the type 2_NT is calculated by the real transmission format. Thus the key issue for this option 3 is to let eNB_T know how the type 2_NT is calculated on UE side. This can be done by UE notifying eNB_T of the calculation way of type 2_NT on UE side, for example, by including special indication in the PHR_NT MAC CE. This option is the most accurate one since the type 2_NT is calculated according to current real situation. Of cause, the option is also based on the exchange of reference format and real transmission format configured for PUCCH transmission between two base stations, as required in option 1 and option 2 respectively.

So, for type 2_NT, the three options are feasible based on the fact the PUCCH reference format or real transmission format will not change dynamically. Hence the exchange of configured PUCCH reference format and/or real transmission format beforehand will guarantee eNB_T can decouple the type 2_NT correctly. This exchange is enabled by defining new X2 procedure in R12. Also, for option 3, new indication should be included in the PHR MAC CE so that eNB_T knows the PUCCH transmission situation of eNB_NT. This will require the enhancement of the PHR MAC CE format.

For type 1_NT calculation, two options can be considered:

Option 1: the type 1_NT is always calculated based on the reference format of PUSCH transmission;

Option 2: the type 1_NT is calculated based on current PUSCH transmission situation when PHR_NT is reported.

For option 1, the configured reference format for PUSCH transmission between two base stations is required to be exchanged beforehand.

For option 2, the key issue is to let eNB know what transmission format is used for type 1_NT calculation, which can be realized based on UE's notification to eNB_T. Of cause, compared with the option 1, the feasibility of option 2 will be challenged on how UE can notify eNB_T on the transmission format information used for type 1_NT calculation. Because the PUSCH transmission format will be dynamically changed per TTI basis, for option 2, UE can inform eNB_T of the current real transmission format information in the same MAC PDU carrying the PHR_NT MAC CE.

So in summary, for type 2_NT, option 1 and option 2 only require two base stations to exchange either the configured PUCCH reference format or configured PUCCH real transmission format, while option 3 has two requirements: the exchange between two base stations of both configured PUCCH reference format and real transmission format and UE should also notify eNB_T of which format is used to calculate the current reported type 2_NT.

For type 1, the option 1 requires the exchange between two base stations of the configured PUSCH reference format. However, the key challenge for option 2 is how UE will notify eNB_T of the transmission format information used to calculate the reported type 1_NT.

3. How to Include PHR_T and PHR_NT in the MAC PDU Transmitted in the eNB_T

As discussed above, when UE reports PHR in DC scenario, two kinds of PHR information, that is, PHR_T and PHR_NT will be included in the same MAC PDU sent over eNB_T. Then the key issue is how to multiplex these two kinds of PHR information in the same MAC PDU. The following two options are proposed:

option 1: PHR_T and PHR_NT are separately multiplexed in the MAC PDU sent on eNB_T;

option 2: PHR_T and PHR_NT are included in the same PHR MAC CE.

Generally speaking, option 1 will lead to higher signaling overhead, because at least two PHR MAC CE sub-headers will be used to send PHR_T and PHR_NT to eNB_T.

The realization of option 1 and option 2 will be separately discussed as below.

(1) Schemes to Achieve Option 1

For option 1, two PHR MAC CEs will be presented in one MAC PDU sent on eNB_T. To guarantee eNB_T to correctly differentiate PHR_T and PHR_NT without any confusion, two schemes can be adopted:

Scheme 1: one new LCID is designed to identify the PHR_NT;

Scheme 2: the “F” bit in the PHR MAC CE sub-header is re-defined to indicate the related PHR payload part is PHR_T or PHR_NT.

For scheme 1, the legacy LCID (11001) for extended PHR MAC CE in R11 is used to identify PHR_T, and one new LCID among (01011-11000) can be defined to identify PHR_NT MAC CE, and vice versa. The benefit of this scheme is there is no impact on PHR MAC CE format and the R11 defined extended PHR MAC CE can be reused. The cost is one reserved LCID should be used to identify PHR_NT MAC CE.

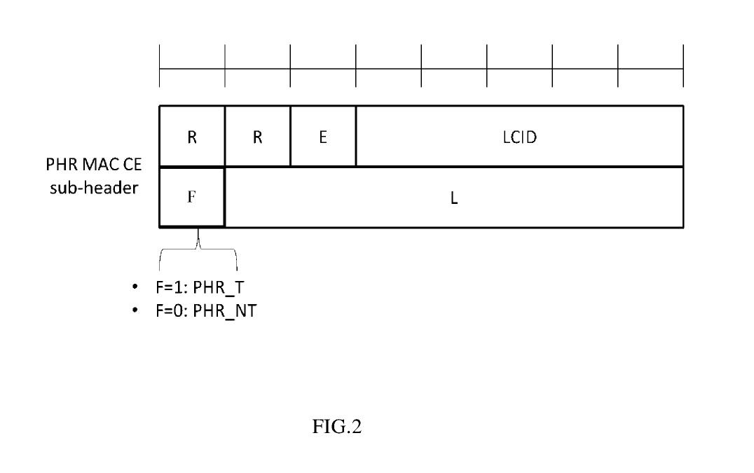

For scheme 2, the separation of PHR_T and PHR_NT is indicated by the PHR MAC CE sub-header. As can be known, for extended PHR MAC CE, the length of payload is variable, hence the related MAC CE sub-header consists of two bytes: R/R/E/LCID+F/L. Here 1-bit ‘F’ field indicates the ‘L’ field is either 7 bit or 15 bit, and the ‘L’ indicates the corresponding PHR MAC CE payload length. In R12, the maximum supported carrier number is no more than 5, hence the ‘L’ field shall be 7 bit and there is no scenario requiring 15-bit ‘L’ field. This means the ‘F’ field in PHR MAC CE is in fact useless for eNB. Thus this ‘F’ bit can be re-defined to indicate the related PHR MAC CE is either PHR_T or PHR_NT, as shown in FIG. 2.

For example, when F=1, it is indicated the related PHR MAC CE is PHR_T; when F=0, it is indicated the related PHR MAC CE is PHR_NT; vice versa.

In summary, these two schemes are feasible in R12 DC scenario so as to guarantee eNB_T can easily distinguish the PHR_T and PHR_NT.

(2) Schemes to Achieve Option 2

For option 2, when UE reports PHR in eNB_T, all PH information of both eNBs is put into one PHR MAC CE which is sent on eNB_T. For this scheme, eNB_T should be able to identify which PH value is for which base station and which active cell.

It is clear that eNB_T knows PHR_T is for which active cells since eNB_T is clear on its own configured cells' active/de-active status. But it is impossible or very hard for eNB_T to know which cell of eNB_NT has PH information included in the PHR_NT part. Taking this situation into account, to enable eNB_T to correctly identify each PH information, following two schemes are proposed:

Scheme 1: the PHR_NT is placed at a fixed position which is directly after the PHR_T payload. Also, one extra byte is added to identify which active cells of eNB_NT have PH information included in PHR_NT.

Scheme 2: the PH information of both eNB_T and eNB_NT are placed according to their corresponding Scell index order, such as ascending order, and X2 procedure is defined for MeNB and SeNB coordination to guarantee there is no Scell index conflict between MeNB and SeNB.

These two schemes will lead to different PHR MAC CE payload format, as discussed below separately.

Solutions to Realize Scheme 1

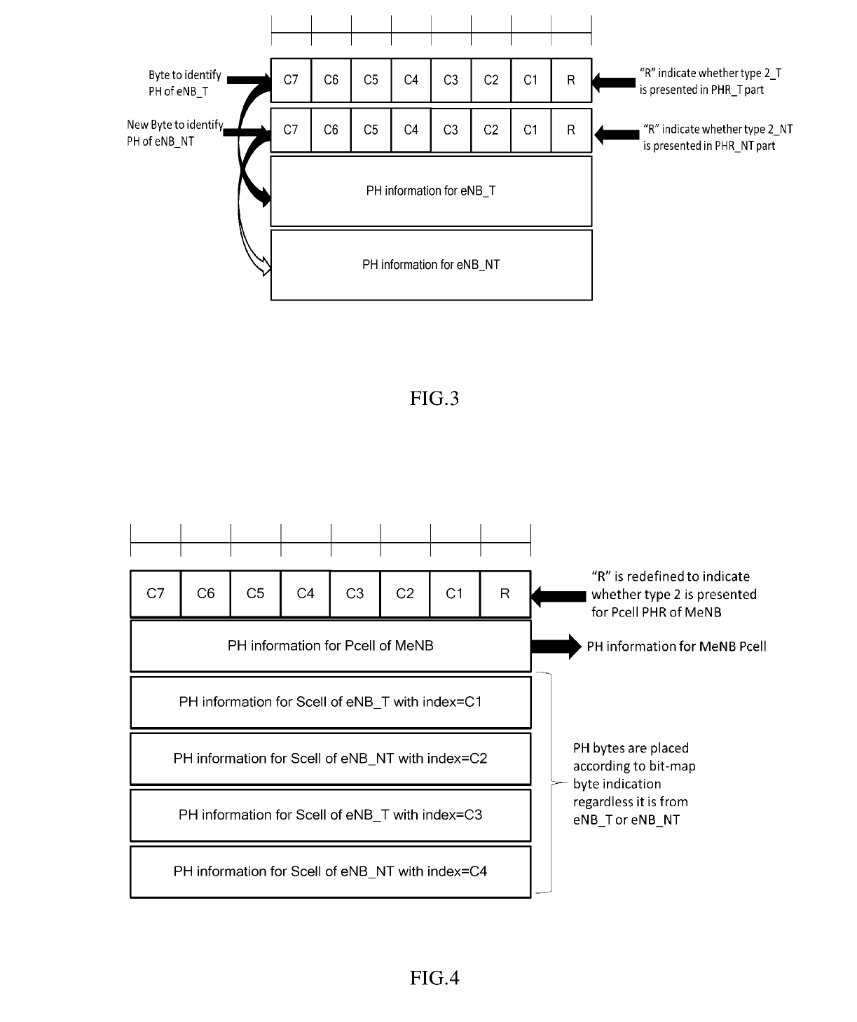

For scheme 1, the R11 defined extended PHR MAC CE payload should be enhanced. The general new PHR payload format is shown in FIG. 3 according to scheme 1.

According to scheme 1 and as shown in FIG. 3, following new rules are proposed:

Two bytes are placed at the beginning position of PHR MAC CE payload, which are used to identify the active cells of eNB_T and eNB_NT respectively; then following the detailed PHR_T and PHR_NT information.

Regardless eNB_T/eNB_NT is MeNB or SeNB, there is scenario that type 2_T and/or type 2_NT may be included in the PHR_T and PHR_NT respectively. From eNB_T perspective, it should first know whether type 2_T is presented such that it can locate the end position of PHR_T and the beginning position of PHR_NT clearly. Also, eNB_T should know whether type 2_NT is presented such that eNB_T can decouple the PHR_NT part correctly. This can be done by re-define the two “R” bits in the first two bit-map bytes of the new MAC CE for this purpose, as shown in FIG. 3.

For example, the “R” of the first bit-map byte indicates whether type 2_T is included in the PHR_T part or not. The “R” of the second bit-map byte indicates whether type 2_NT is presented in the PHR_NT part or not. Based on this proposal, eNB_T can locate the end position of PHR_T correctly, and then eNB_T can decouple the PHR_NT part correctly based on the second bit-map byte information.

So in summary, scheme 1 proposes to enhance the R11 defined PHR MAC CE payload format as below:
Two bit-map bytes are placed at the beginning position of PHR MAC CE payload, which are used to identify which active cells of eNB_T and eNB_NT are reporting PH information, wherein the first bit-map byte is used to identify the active cells of eNB_T and the second bit-map byte is used to identify the active cells of eNB_NT.
The “R” bits of the first two bytes are used to identify whether type 2_T/type 2_NT is presented in the PHR_T/PHR_NT part respectively.
The PHR_T and PHR_NT are placed at fixed sequence, where PHR_NT is closely following PHR_T,

It shall be appreciated that in a variation of the embodiments shown in FIG. 3, only “R” bit of the bit-map type (i.e., the first bit-map type in the PHR MAC CE payload when eNB_T is MeNB; the second bit-map type in the PHR MAC CE payload when eNB_NT is MeNB) corresponding to the MeNB can be used to indicate whether the PUCCH PH value of the Pcell of the MeNB is included in the PH information of the active cells of the MeNB or not. Correspondingly, at the eNB_T side, whether the PUCCH PH value of the SPcell of the SeNB is included in the PH information of the active cells of the SeNB or not can be determined based on the “R” bit of the bit-map type corresponding to the MeNB. To be specific, for example, “R”=1 of the bit-map byte corresponding to the MeNB is used for indicating the PUCCH PH value of the Pcell of the MeNB is included in the payload of the PHR MAC CE, and “R”=0 is used for indicating the PUCCH PH value of the Pcell of the MeNB is not included in the payload of the PHR MAC CE. Then whether the PUCCH PH value of the SPcell of the SeNB is included in the PH information of the active cells of the SeNB or not can be determined by the followings ways:

when “R”=1,
if [N_{L}−2−2−the number of active bits]=1, then the PUCCH PH value of the SPcell of the SeNB is included in the PH information of the active cells of the SeNB;
if [N_{L}−2−2−the number of active bits]=0, then the PUCCH PH value of the SPcell of the SeNB is not included in the PH information of the active cells of the SeNB;

wherein N_{L} represents the byte number indicated by the “L” field in the sub-header of the PHR MAC CE, the first “2” in the equation represents PUCCH PH byte and PUSCH PH byte of the Pcell of MeNB, the second “2” in the equation represents the number of bit-map bytes, and “the number of active bits” represents the number of all active Scells of the MeNB and the SeNB;

when “R”=0,
if [N_{L}−1−2−the number of active bits]=1, then the PUCCH PH value of the SPcell of the SeNB is included in the PH information of the active cells of the SeNB;
if [N_{L}−1−2−the number of active bits]=0, then the PUCCH PH value of the SPcell of the SeNB is not included in the PH information of the active cells of the SeNB;

wherein N_{L} represents the byte number indicated by the “L” field in the sub-header of the PHR MAC CE, the first “1” in the equation represents PUSCH PH byte of the Pcell of MeNB, the second “2” in the equation represents the number of bit-map bytes, and “the number of active bits” represents the number of all active Scells of the MeNB and the SeNB.

Solutions to Realize Scheme 2

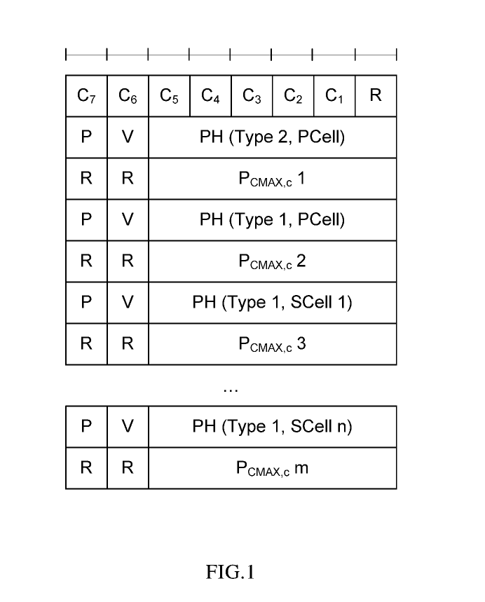

Scheme 2 is based on such an assumption that the total number of configured cells for DC UE is not beyond 8, which covers all cells belonging to MeNB and SeNB. This assumption has already been agreed in previous meeting. So in theory speaking, one byte is enough to cover all configured cells of both MeNB and SeNB. Hence the R11 defined extended PHR MAC CE payload can be reused. The only issue is to avoid cell index conflict between eNB_T and eNB_NT. This can be done by define new X2 procedure such that each base station should notify each other of the configured Scell index information. The target is to guarantee one base station will not use cell index which is already used by another base station. Then in the legacy R11 defined extended PHR MAC CE payload, the first bit-map byte as shown in FIG. 1 can identify all active cells with PH value included in this MAC CE, regardless of the active cell belonging to eNB_T or eNB_NT. Since eNB_T is clear on its own configured cells active/de-active status, eNB_T can clearly identify and distinguish the PHR_T and PHR_NT based on the bit-map byte.

In the PHR MAC CE payload part, regardless eNB_T is MeNB or SeNB, eNB_T knows the PH value for Pcell of MeNB will always be included since Pcell of MeNB is always active and the Pcell index is 000. So it is proposed that the MeNB Pcell PH can always be placed at the first position as shown in FIG. 4. Thus regardless the eNB_T is which base station, eNB_T knows the first PH value must be for MeNB Pcell and the following PH bytes are for Scell of either eNB_T or eNB_NT, which is identified by bit-map byte according to related Scell's index information.

The only issue is that eNB_T must know whether type 2 for Pcell and/or type 2 for SPcell are presented in MAC CE payload or not so as to correctly decouple the received PHR MAC CE. This can be solved by re-defining the “R” of the bit-map byte for this purpose. For example, this “R” is defined to indicate whether type 2 is included for MeNB's Pcell PHR. Then eNB_T can deduce whether SPcell's type 2 is presented or not by the “L” filed in PHR MAC CE sub-header and the number of active cells indicated by the first bit-map byte in the MAC CE payload part. For example, following rules can be proposed for this purpose, where we assume Pcmax is not presented:
if “R”=1, which indicates type 2 for MeNB Pcell is presented; then if N_{L}−2 (type 2 and type 1 of Pcell)−1 (the number of bit-map bytes)−the number of active bits (type 1 for all active Scells of eNB_T and eNB_NT)=1, then type 2 for SPcell is presented;

if N_{L}−2 (types 2 and type 1 of Pcell)−1 (the number of bit-map bytes)−the number of active bits (type 1 for all active Scells of eNB_T and eNB_NT)=0, then no type 2 for SPcell is presented.
if “R”=0, which indicate type 2 for MeNB Pcell is not presented;

then if N_{L}−1 (types 1 of Pcell)−1 (the number of bit-map bytes)−the number of active bits (type 1 for all active Scells of eNB_T and eNB_NT)=1, then type 2 for SPcell is presented;

if N_{L}−1 (types 1 of Pcell) −1 (the number of bit-map bytes)−the number of active bits (type 1 for all active Scells of eNB_T and eNB_NT)=0, then no type 2 for SPcell is presented.

If Pcmax is presented, then the above two principles still work for SPcell type 2, as long as the number of Pcmax bytes is subtracted.

Therefore, scheme 2 is also feasible with the cost to re-define “R” bit of bit-map byte and define new X2 coordination procedure to guarantee there is no Scell index conflict between MeNB and SeNB.

According to above option 1 and option 2, eNB_T can correctly identify each PH is for which base station and which alive cell.

It is to be noted that the above embodiments are just exemplary but will not limit to the present invention. Any technical solutions without departing from the spirit or essence of the invention shall fall into the protection scope of the present invention, which includes using different technical features, apparatuses and methods in different embodiments to combine so as to achieve notable effects. Moreover, any reference numerals in the claim shall not be regarded as limiting the claim; the term “comprising” will not preclude element(s) or step(s) which are not presented in other claims or specification. The technical solutions of the present invention can be achieved by software, hardware or their combination.

1. A method of providing a PHR MAC CE of a SeNB to the SeNB in a user equipment of a dual connectivity scenario, the method comprising:
sending the PHR MAC CE of the SeNB to the SeNB, the PHR MAC CE including PH information of SPcell of the SeNB and PH information of one or more active Scells of the SeNB, wherein the PH information of the SPcell is placed at a beginning position of a payload of the PHR MAC CE and the PH information of the Scells is placed at a subsequent position closely after the beginning position based on index sequences of the Scells, or the PH information of the SPcell is placed at an end position of a payload of the PHR MAC CE and the PH information of the Scells is placed at a preceding position closely before the end position based on index sequences of the Scells.

2. (canceled)

3. The method of claim 1, wherein when the payload of the PHR MAC CE includes both PUSCH PH information and PUCCH PH information of the SPcell, the PUCCH PH information of the SPcell is placed at any one of the following positions in the payload of the PHR MAC CE:
directly placed at a position closely before the PUSCH PH information of the SPcell;
directly placed at a position closely after the PUSCH PH information of the SPcell.

4. (canceled)

5. (canceled)

6. A method of calculating a PUCCH PH value of a Pcell/SPcell of an eNB_NT in a user equipment of a dual connectivity scenario, the method comprising:
calculating the PUCCH PH value of the Pcell/SPcell based on a reference format of a PUCCH transmission of the Pcell/SPcell.

7. A method of calculating a PUCCH PH value of a Pcell/SPcell of an eNB_NT in a user equipment of a dual connectivity scenario, the method comprising:
calculating the PUCCH PH value of the Pcell/SPcell based on a real PUCCH transmission format of the Pcell/SPcell in a current TTI.

8. A method of calculating a PUCCH PH value of a Pcell/SPcell of an eNB_NT in a user equipment of a dual connectivity scenario, the method comprising:
determining whether there is a PUCCH transmission of the Pcell/SPcell or not when the PUCCH PH value of the Pcell/SPcell is reported;
if there is no PUCCH transmission, then calculating the PUCCH PH value of the Pcell/SPcell based on a reference format of a PUCCH transmission of the Pcell/SPcell;
if there is a PUCCH transmission, then calculating the PUCCH PH value of the Pcell/SPcell based on a real PUCCH transmission format of the Pcell/SPcell when the PUCCH PH value of the Pcell/SPcell is reported.

9. (canceled)

10. A method of calculating PUSCH PH values of a Pcell/SPcell and one or more active Scells of an eNB_NT in a user equipment of a dual connectivity scenario, the method comprising:
calculating the PUSCH PH values of the Pcell/SPcell and the Scells respectively based on a reference format of a PUSCH transmission of the Pcell/SPcell and the Scells.

11. A method of calculating PUSCH PH values of a Pcell/SPcell and one or more active Scells of an eNB_NT in a user equipment of a dual connectivity scenario, the method comprising:
calculating the PUSCH PH values of the Pcell/SPcell and the Scells based on a current real PUSCH transmission format of the Pcell/SPcell and the Scells when the PUSCH PH values of the Pcell/SPcell and the Scells are reported.

12.-14. (canceled)

15. A method of providing a PHR MAC CE to an eNB_T in a user equipment of a dual connectivity scenario, the method comprising:
sending a MAC PDU to the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a first bit-map byte, a second bit-map byte closely following the first bit-map byte, the PH information of the active cells of the eNB_T closely following the second bit-map byte, and the PH information of the active cells of the eNB_NT closely following the PH information of the active cells of the eNB_T, and wherein the first bit-map byte is used for indicating which active cell(s) of the eNB_T has PH information included in the payload of the PHR MAC CE and the second bit-map byte is used for indicating which active cell(s) of the eNB_NT has PH information included in the payload of the PHR MAC CE; and
a “R” bit in the first bit-map byte is used for indicating whether a PUCCH PH value of a Pcell/SPcell of the eNB_T is included in the PH information of the active cells of the eNB_T, and a “R” bit in the second bit-map byte is used for indicating whether a PUCCH PH value of a Pcell/SPcell of the eNB_NT is included in the PH information of the active cells of the eNB_NT; or
a “R” bit of a bit-map byte corresponding to a MeNB is used for indicating whether a PUCCH PH value of a Pcell of the MeNB is included in PH information of active cells of the MeNB.

16. A method of providing a PHR MAC CE to an eNB_T in a user equipment of a dual connectivity scenario, the method comprising:
sending a MAC PDU to the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a bit-map byte for indicating which active cell(s) of the eNB_T has PH information included in the payload of the PHR MAC CE and which active cell(s) of the eNB_NT has PH information included in the payload of the PHR MAC CE, and the payload of the PHR MAC CE further includes PH information of a Pcell of a MeNB closely following the bit-map byte, and PH information of one or more active Scells of the MeNB and all active cells of the SeNB, closely following the PH information of the Pcell of the MeNB, arranged based on index sequences of the active Scells of the MeNB and the all active cells of the SeNB, and wherein a “R” bit in the bit-map byte is used for indicating whether a PUCCH PH value of the Pcell of the MeNB is included in the payload of the PHR MAC CE.

17. A method of receiving a PHR MAC CE in a SeNB of a dual connectivity scenario, the method comprising:
receiving the PHR MAC CE of the SeNB from a user equipment, the PHR MAC CE including PH information of SPcell of the SeNB and PH information of one or more active Scells of the SeNB, wherein the PH information of the SPcell is placed at a beginning position of a payload of the PHR MAC CE and the PH information of the Scells is placed at a subsequent position closely after the beginning position based on index sequences of the Scells, or the PH information of the SPcell is placed at an end position of a payload of the PHR MAC CE and the PH information of the Scells is placed at a preceding position closely before the end position based on index sequences of the Scells;
determining whether [N_{L}−1−n−the number of Pcmax bytes]=0 or 1;
if [N_{L}−1−n−the number of Pcmax bytes]=0, then it is determined the payload of the PHR MAC CE includes only PUSCH PH information of the SPcell;
if [N_{L}−1−n−the number of Pcmax bytes]=1, then it is determined the payload of the PHR MAC CE includes both PUSCH PH information and PUCCH PH information of the SPcell;
ignoring index of the SPcell and decoupling the PHR MAC CE;
wherein N_{L} represents the byte number indicated by a “L” field in a sub-header of the PHR MAC CE, “1” represents the number of bit-map bytes “n” represents the number of active cells of the SeNB with PH information included in the payload of the PHR MAC CE, and “the number of Pcmax bytes” represents the number of “P”=1 in each PH information byte.

18. (canceled)

19. A method of processing a PUCCH PH value of a Pcell/SPcell of an eNB_NT in an eNB_T of a dual connectivity scenario, the method comprising:
exchanging with the eNB_NT each other's configured reference format of PUCCH transmission via an X2 interface;
receiving from a user equipment a PHR MAC CE in which the PUCCH PH value of the Pcell/SPcell of the eNB_NT is included;
decoupling the PUCCH PH value of the Pcell/SPcell in the PHR MAC CE according to the configured reference format of PUCCH transmission of the eNB_NT.

20. A method of processing a PUCCH PH value of a Pcell/SPcell of an eNB_NT in an eNB_T of a dual connectivity scenario, the method comprising:
exchanging with the eNB_NT each other's current configured PUCCH transmission format via an X2 interface;
receiving from a user equipment a PHR MAC CE in which the PUCCH PH value of the Pcell/SPcell of the eNB_NT is included;
decoupling the PUCCH PH value of the Pcell/SPcell in the PHR MAC CE according to the current configured PUCCH transmission format of the eNB_NT.

21. (canceled)

22. A method of processing a PUCCH PH value of a Pcell/SPcell of an eNB_NT in an eNB_T of a dual connectivity scenario, the method comprising:
exchanging with the eNB_NT each other's configured reference format of PUCCH transmission and each other's current configured PUCCH transmission format via an X2 interface;
receiving from a user equipment a PHR MAC CE in which the PUCCH PH value of the Pcell/SPcell of the eNB_NT is included and information about a calculating way by which the PUCCH PH value of the Pcell/SPcell is calculated at the user equipment side;
decoupling the PUCCH PH value of the Pcell/SPcell in the PHR MAC CE based on the calculating way by which the PUCCH PH value of the Pcell/SPcell is calculated at the user equipment side and according to one of the configured reference format of PUCCH transmission of the eNB_NT and the current configured PUCCH transmission format of the eNB_NT corresponding to the calculating way.

23. (canceled)

24. A method of processing PUSCH PH values of a Pcell/SPcell and one or more active Scells of an eNB_NT in an eNB_T of a dual connectivity scenario, the method comprising:
exchanging with the eNB_NT each other's configured reference format of PUSCH transmission via an X2 interface;
receiving from a user equipment a PHR MAC CE in which the PUSCH PH values of the Pcell/SPcell and the Scells of the eNB_NT are included;
decoupling the PUSCH PH values of the Pcell/SPcell and the Scells in the PHR MAC CE according to the configured reference format of PUSCH transmission of the eNB_NT.

25. A method of processing PUSCH PH values of a Pcell/SPcell and one or more active Scells of an eNB_NT in an eNB_T of a dual connectivity scenario, the method comprising:
receiving from a user equipment a PHR MAC CE in which the PUSCH PH values of the Pcell/SPcell and the Scells of the eNB_NT are included, a MAC PDU carrying the PHR MAC CE further including information for indicating a current real transmission format of the eNB_NT;
decoupling the PUSCH PH values of the Pcell/SPcell and the Scells in the PHR MAC CE according to the current real transmission format of the eNB_NT.

26. (canceled)

27. A method of processing a PHR MAC CE in an eNB_T of a dual connectivity scenario, the method comprising:
receiving a MAC PDU from the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a first bit-map byte, a second bit-map byte closely following the first bit-map byte, the PH information of the active cells of the eNB_T closely following the second bit-map byte, and the PH information of the active cells of the eNB_NT closely following the PH information of the active cells of the eNB_T, and wherein the first bit-map byte is used for indicating which active cell(s) of the eNB_T has PH information included in the payload of the PHR MAC CE and the second bit-map byte is used for indicating which active cell(s) of the eNB_NT has PH information included in the payload of the PHR MAC CE; and a “R” bit in the first bit-map byte is used for indicating whether a PUCCH PH value of a Pcell/SPcell of the eNB_T is included in the PH information of the active cells of the eNB_T, and a “R” bit in the second bit-map byte is used for indicating whether a PUCCH PH value of Pcell/SPcell of the eNB_NT is included in the PH information of the active cells of the eNB_NT;
determining a terminating position of the PH information of the active cells of the eNB_T and decoupling the PH information corresponding to the active cells of the eNB_T in the payload of the PHR MAC CE and the PH information corresponding to the active cells of the eNB_NT in the payload of the PHR MAC CE based on the “R” bit in the first bit-map byte and the “R” bit in the second bit-map byte.

28. A method of processing a PHR MAC CE in an eNB_T of a dual connectivity scenario, the method comprising:
receiving a MAC PDU from the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a first bit-map byte, a second bit-map byte closely following the first bit-map byte, the PH information of the active cells of the eNB_T closely following the second bit-map byte, and the PH information of the active cells of the eNB_NT closely following the PH information of the active cells of the eNB_T, and wherein the first bit-map byte is used for indicating which active cell(s) of the eNB_T has PH information included in the payload of the PHR MAC CE and the second bit-map byte is used for indicating which active cell(s) of the eNB_NT has PH information included in the payload of the PHR MAC CE; and a “R” bit of a bit-map byte corresponding to a MeNB is used for indicating whether a PUCCH PH value of a Pcell of the MeNB is included in PH information of active cells of the MeNB;
determining whether a PUCCH PH value of a SPcell of a SeNB is included in PH information of active cells of the SeNB based on the “R” bit of the bit-map byte corresponding to the MeNB;
determining a terminating position of the PH information of the active cells of the eNB_T and decoupling the PH information corresponding to the active cells of the eNB_T in the payload of the PHR MAC CE and the PH information corresponding to the active cells of the eNB_NT in the payload of the PHR MAC CE based on whether the PUCCH PH value of the Pcell of the MeNB is included in PH information of the active cells of the MeNB and whether the PUCCH PH value of the SPcell of the SeNB is included in the PH information of the active cells of the SeNB.

29. The method of claim 28, wherein “R”=1 of the bit-map byte corresponding to the MeNB is used for indicating the PUCCH PH value of the Pcell of the MeNB is included in the payload of the PHR MAC CE, and “R”=0 is used for indicating the PUCCH PH value of the Pcell of the MeNB is not included in the payload of the PHR MAC CE, wherein whether the PUCCH PH value of the SPcell of the SeNB is included in the PH information of the active cells of the SeNB or not is determined by the followings ways:
when “R”=1,
if [N_{L}−2−2−the number of active bits in the first bit-map type and the second bit-map type−the number of Pcmax bytes]=1, then the PUCCH PH value of the SPcell of the SeNB is included in the PH information of the active cells of the SeNB;
if [N_{L}−2−2−the number of active bits in the first bit-map type and the second bit-map type−the number of Pcmax bytes]=0, then the PUCCH PH value of the SPcell of the SeNB is not included in the PH information of the active cells of the SeNB;
wherein N_{L} represents the byte number indicated by a “L” field in a sub-header of the PHR MAC CE, the first “2” in the equation represents PUCCH PH byte and PUSCH PH byte of the Pcell of MeNB, the second “2” in the equation represents the number of bit-map bytes, and “the number of active bits” represents the number of all active Scells of the MeNB and the SeNB;
when “R”=0,
if [N_{L}−1−2−the number of active bits in the first bit-map type and the second bit-map type−the number of Pcmax bytes]=1, then the PUCCH PH value of the SPcell of the SeNB is included in the PH information of the active cells of the SeNB;
if [N_{L}−1−2−the number of active bits in the first bit-map type and the second bit-map type−the number of Pcmax bytes]=0, then the PUCCH PH value of the SPcell of the SeNB is not included in the PH information of the active cells of the SeNB;
wherein N_{L} represents the byte number indicated by a “L” field in a sub-header of the PHR MAC CE, the first “1” in the equation represents PUSCH PH byte of the Pcell of MeNB, the second “2” in the equation represents the number of bit-map bytes, and “the number of active bits” represents the number of all active Scells of the MeNB and the SeNB.

30. A method of processing a PHR MAC CE in an eNB_T of a dual connectivity scenario, the method comprising:
receiving a MAC PDU from the eNB_T, the MAC PDU including a PHR MAC CE, a payload of the PHR MAC CE including PH information corresponding to active cells of the eNB_T and PH information corresponding to active cells of an eNB_NT, wherein the payload of the PHR MAC CE includes a bit-map byte for indicating which active cell(s) of the eNB_T has PH information included in the payload of the PHR MAC CE and which active cell(s) of the eNB_NT has PH information included in the payload of the PHR MAC CE, and the payload of the PHR MAC CE further includes PH information of a Pcell of a MeNB closely following the bit-map byte, and PH information of one or more active Scells of the MeNB and all active cells of the SeNB, closely following the PH information of the Pcell of the MeNB, arranged based on index sequences of the active Scells of the MeNB and the all active cells of the SeNB, and wherein a “R” bit in the bit-map byte is used for indicating whether a PUCCH PH value of the Pcell of the MeNB is included in the payload of the PHR MAC CE;
determining whether a PUCCH PH value of a SPcell of the SeNB is included in the PH information of the active cells of the SeNB or not based on the “R” bit in the bit-map byte.

31. The method of claim 30, wherein “R”=1 of the bit-map byte is used for indicating the PUCCH PH value of the Pcell of the MeNB is included in the payload of the PHR MAC CE, and “R”=0 is used for indicating the PUCCH PH value of the Pcell of the MeNB is not included in the payload of the PHR MAC CE, wherein whether the PUCCH PH value of the SPcell of the SeNB is included in the payload of the PHR MAC CE or not is determined by the followings ways:
when “R”=1,
if [N_{L}−2−1−the number of active bits−the number of Pcmax bytes]=1, then the PUCCH PH value of the SPcell of the SeNB is included in the payload of the PHR MAC CE;
if [N_{L}−2−1−the number of active bits−the number of Pcmax bytes]=0, then the PUCCH PH value of the SPcell of the SeNB is not included in the payload of the PHR MAC CE;
wherein N_{L} represents the byte number indicated by a “L” field in a sub-header of the PHR MAC CE, the first “2” in the equation represents PUCCH PH byte and PUSCH PH byte of the Pcell of MeNB, the second “1” in the equation represents the number of bit-map bytes, and “the number of active bits” represents the number of all active Scells of the MeNB and the SeNB;
when “R”=0,
if [N_{L}−1−1−the number of active bits−the number of Pcmax bytes]=1, then the PUCCH PH value of the SPcell of the SeNB is included in the payload of the PHR MAC CE;
if [NH-1−the number of active bits−the number of Pcmax bytes]=0, then the PUCCH PH value of the SPcell of the SeNB is not included in the payload of the PHR MAC CE;
wherein N_{L} represents the byte number indicated by a “L” field in a sub-header of the PHR MAC CE, the first “1” in the equation represents PUSCH PH byte of the Pcell of MeNB, the second “1” in the equation represents the number of bit-map bytes, and “the number of active bits” represents the number of all active Scells of the MeNB and the SeNB.

32. (canceled)
